(19) United States
(12) Patent Application Publication
(10) Pub. No.: US 2002/0138326 A1
(43) Pub. Date: Sep. 26, 2002

(54) System and method for group scheduling using a wireless device

(76) Inventors: Leo Parker, Charlestown, MA (US); Vladimir Umansky, Newton, MA (US); Kellan Elliot-McCrea, Somerville, MA (US); Beth Johnson, Lynnfield, MA (US); Darsono Sutedja, Dorchester, MA (US)

Correspondence Address: BROMBERG & SUNSTEIN LLP, 125 SUMMER STREET, BOSTON, MA, 02110-1618, US

(21) Appl. No.: 09/814,563

(22) Filed: Mar. 22, 2001

(51) Int. Cl. G06F 17/60

(52) U.S. Cl. 705/9

(57) ABSTRACT

A method of using a wireless scheduling device to determine schedule availability for a set of attendees includes communicating an availability request to a server using the wireless scheduling device. The server has access to calendar data for each attendee on the set of attendees. In response to the availability request, a search is conducted of the calendar data of each attendee to produce an availability data set. The availability data set is transmitted to the wireless scheduling device. The availability data set may then be displayed on the wireless scheduling device.

### TECHNICAL FIELD

The present invention relates to systems and methods for personal information management, in particular, determining availability and group scheduling using a wireless device in communication with a computer network, in particular, the Internet.

### BACKGROUND ART

Personal information managers (“PIMs”) and personal digital assistants (“PDAs”) are well known in the prior art. PIMs are software applications that are designed to help users organize information such as, for example, calendars or schedules, dates, lists, reminders and contacts and may be implemented on a personal computer or PDA. In addition, PIM's may be implemented as Web sites on the World Wide Web.

Wireless devices, such as PDA's and cellular telephones, may be used to access the Internet and applications provided over the Internet. PDA's and cellular telephones, however, typically have small displays and keypads, and small amounts of memory. These factors present challenges in accessing and displaying information transferred between wireless devices and the Internet.

### SUMMARY OF THE INVENTION

In accordance with one aspect of the invention, a method of using a wireless device to determine schedule availability for a set of attendees includes communicating an availability request to a server using the wireless scheduling device where the server has access to calendar data for each attendee in the set of attendees. The availability request may be communicated to the server via a network, such as a network that includes the Internet. In response to the availability request, a search is conducted of the calendar data for each attendee of the set to produce an availability data set. The availability data set is then transmitted to the wireless scheduling device. The method may further include displaying data derived from the availability data set on the wireless scheduling device. In one embodiment, the data derived from the availability data set is displayed as free time and busy time.

In another embodiment, the availability request includes an identifier for each attendee and a time period for which availability should be determined. The identifier for each attendee may be an email address. The calendar data for each attendee may be stored in an availability database that is in communication with the server. In a further embodiment, the method includes scheduling an event based on the availability data set. The event may be scheduled using the wireless scheduling device. In yet another embodiment, the method further includes updating the calendar data for each attendee with the scheduled event. the method may also include requesting access to the calendar data for each attendee in the set of attendees. Access to the calendar data may be requested via email over the Internet.

In accordance with another aspect of the invention, a system for determining schedule availability of a set of attendees using a wireless scheduling device includes a first process, running on the wireless scheduling device that is in communication with a server, for communicating an availability request to the server where the server has access to calendar data for each attendee in the set of attendees. The availability request may be communicated to the server via a network, such as a network that includes the Internet. The system further includes a second process, running on the server, for conducting a search of the calendar data of each attendee of the set to produce an availability data set in response to the availability request and a third process, running on the server, for transmitting the availability data set to the wireless scheduling device.

In one embodiment, the system may further include a fourth process, running on the wireless scheduling device, for displaying data derived from the availability data set on the wireless scheduling device. The data derived from the availability data set may be displayed as free time and busy time. In another embodiment, the availability request includes an identifier for each attendee and a time period for which availability should be determined. The identifier for each attendee may be an email address.

In accordance with yet another aspect of the invention, a wireless scheduling devices includes availability logic for creating an availability request to determine schedule availability for a set of attendees, transmission logic for communicating the availability request to a server where the server has access to calendar data for each attendee and receiving logic for receiving an availability data set produced at the server in response to the availability request. The wireless scheduling device may also include display logic for displaying data derived from the availability data set.

### BRIEF DESCRIPTION OF THE DRAWINGS

The foregoing features of the invention will be more readily understood by reference to the following detailed description, taken with reference to the accompanying drawings, in which:

FIG. 1 is a block diagram of the logical flow of a method for determining the availability of a set of attendees using a wireless scheduling device in accordance with an embodiment of the invention.

FIGS. 2a and 2b illustrate an exemplary application for providing information for an availability request in accordance with an embodiment of the invention.

FIGS. 3a and 3b illustrate an exemplary display on a wireless scheduling device of an availability data set in accordance with an embodiment of the invention.

FIG. 4 is shows a system for determining schedule availability for a set of attendees in accordance with an embodiment of the invention.

FIG. 5 is a block diagram of a wireless scheduling device used to determine schedule availability in accordance with an embodiment of the invention.

FIG. 6 shows an exemplary request for permission to access an attendee's calendar data in accordance with an embodiment of the invention.

FIG. 7 shows an exemplary response regarding permission to access calendar data in accordance with an embodiment of the invention.

### DETAILED DESCRIPTION OF SPECIFIC EMBODIMENTS

Definitions.

As used in this description and the accompanying claims, the following terms shall have the meanings indicated, unless the context otherwise requires:

“Attendee” means an individual who will be invited to an event.

“Availability request” means a request for information regarding when an individual or group of individuals is available for a specified time frame.

“Availability data set” means data indicating, either for an individual or for a group, generically either free space in a schedule or busy space in a schedule or both free and busy space.

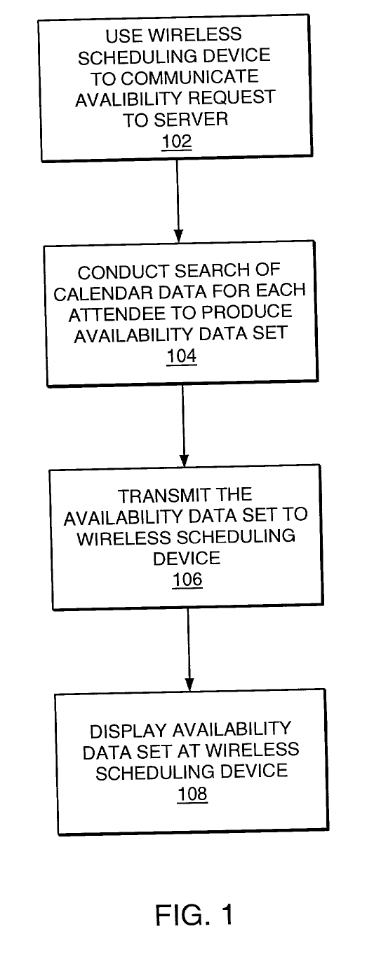

When an individual wishes to schedule an event (e.g., a meeting, conference, etc.) involving another individual or group of individuals it is advantageous to have access to the schedule availability of the other individual or of the group of individuals to determine an appropriate time to schedule the event. FIG. 1 is a block diagram of the logical flow of a method for determining the availability of a set of attendees using a wireless scheduling device in accordance with an embodiment of the invention. As mentioned above, an attendee is an individual who will be invited to an event. At block 102, a user (i.e., a person scheduling an event) uses a wireless scheduling device to communicate an availability request to a server. The wireless scheduling device may be, for example, a hand held device such as a cellular telephone or Personal Digital Assistant (“PDA”). In one embodiment, the wireless scheduling device may be a PDA such as the Palm VII or Palm VIIx provided by Palm, Inc. of Santa Clara, Calif. A PDA may be used to access a computer network, such as the Internet, using wireless modems that may be external or built-in to the PDA device. Typically, a wireless PDA is in communication with the computer network via an intermediate wireless network facility.

As mentioned above, the availability request is a request for information regarding when an individual or group of individuals is available for a specified time frame. For example, a user may wish to determine when an attendee is available for a meeting during a particular week or on a particular day. In one embodiment, an availability request includes information such as an identifier for the user making the request, the starting date for which availability information is desired, the number of days of availability information desired and an identifier for each attendee for which the user wants availability information. The identifier for each attendee may be, for example, an email address. One example of an availability request is a request to view the free and busy time for a set of attendees on a particular day. Alternatively, an availability request may be a request to locate the first block of free time available for all attendees.

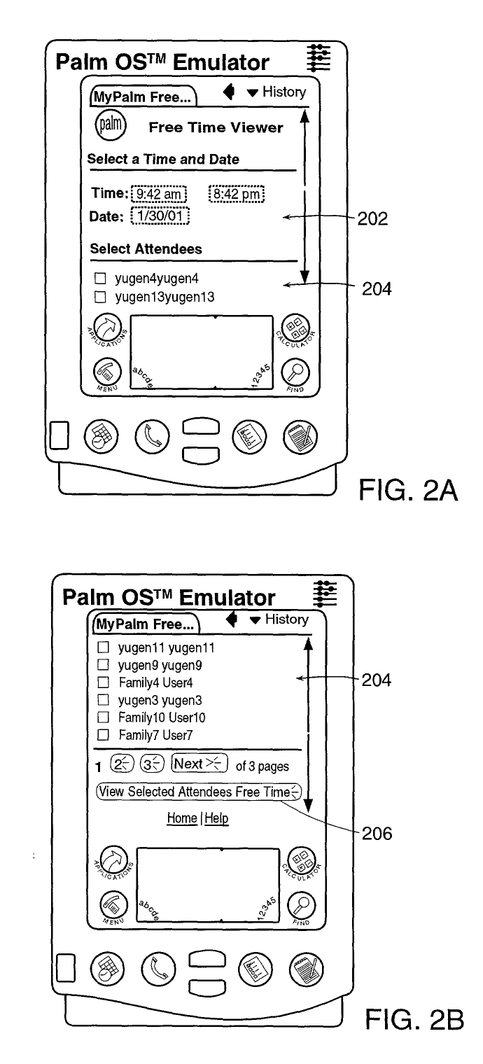

FIGS. 2a and 2b illustrate an exemplary application for providing information for an availability request on a wireless scheduling device in accordance with an embodiment of the invention. In the embodiment shown in FIGS. 2a and 2b, the wireless scheduling device is a PDA. The PDA application may be implemented using methods of general knowledge in the art, such as, for example, Palm Query Applications (“PQA's”). In FIG. 2a, the user may provide a time frame 202 for the availability request. In this example, a time range and date 202 have been provided for the availability request. The user then selects a set of attendees from a list of possible attendees 204 for which the user wishes to determine availability for the event being scheduled by the user. In one embodiment, the user may only view availability data for attendees that have granted the user permission to access their availability data. Accordingly, in this embodiment, each attendee in the set of attendees 204 has granted permission to the user to access their availability information. The permission information for each attendee may be stored with calendar data at the server to which the availability request is sent by the wireless scheduling device. Exemplary methods of obtaining permission to access an attendee's availability information are discussed in more detail below.

Returning to FIG. 2a, the user selects an attendee by selecting a check box associated with the particular attendee. In one embodiment, each attendee 204 is identified by an email address. In FIG. 2b, once the user has selected a set of attendees, the user may transmit the availability request by selecting to view the attendees' availability 206.

Returning to FIG. 1, at block 102 the availability request is communicated from the wireless scheduling device to a server. The server may be a single server or multiple servers. The server has access to calendar or schedule information for each attendee in the set of attendees. For example, in one embodiment, the server is coupled to a database of availability data including calendar data for the set of attendees. The database of availability data may be associated with a PIM. As discussed previously, a PIM may be implemented as an application on a personal computer or as a Web site on the World Wide Web. For more information regarding a Web-based PIM see co-pending patent application Ser. No. 09/498,516, filed Feb. 2, 2000, attorney docket number 2378/101 and co-pending patent application Ser. No. 09/693,543, filed Oct. 20, 2000, attorney docket number 2378/103, which applications are hereby incorporated by reference.

At block 104, a search is conducted of the calendar data of each attendee in the set of attendees in response to the availability request. In one embodiment, the calendar data is stored in a database in communication with the server. The calendar data search produces an availability data set. As discussed above, an availability data set is data indicating, either for an individual or for a group, generically either free space in a schedule or busy space in a schedule or both free and busy space. The details of events in an attendee's schedule, other than the time frame in which the appointment occurs, are not included in the availability data set. A benefit of the concise nature of the information in the availability data set is the ease with which such information may be communicated over the relatively slow data communication channels associated with wireless devices.

In other embodiments, it is possible to include or exclude from the availability data set selected types of information. For example, free-busy information for individuals may be sacrificed to make the availability data set even more compact, containing only free-busy information for the group. Alternatively, the availability data set may additionally include, for example, generic indicators for the type of engagement for which an attendee is busy (for example, a company meeting, personal engagement, vacation, etc.), and each type of engagement may be identified optionally from a check list of types.

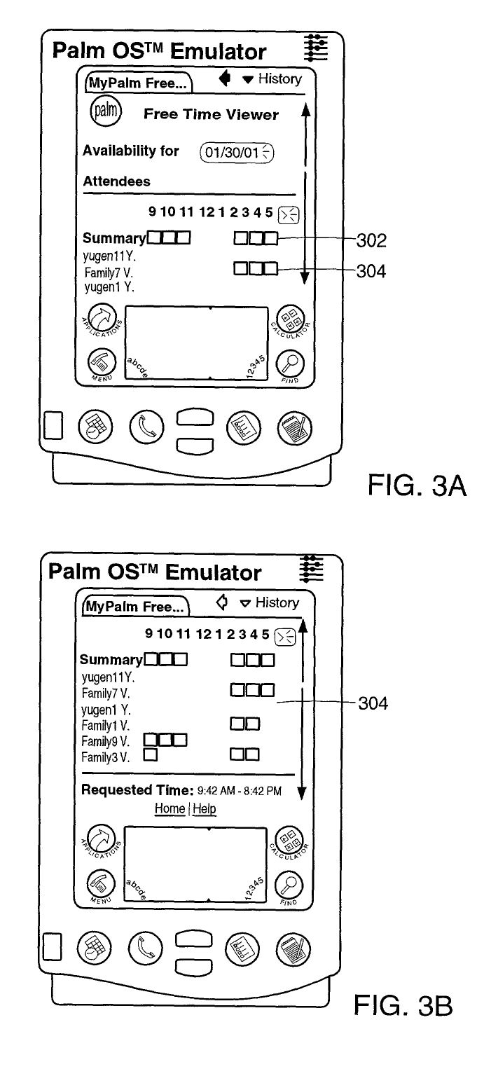

At block 106, the availability data set is transmitted from the server to the wireless scheduling device. The availability data set may then be displayed on the wireless scheduling device at block 108. In one embodiment, the availability data set is displayed as periods of time which either include an event (i.e., “busy”) or do not include an event (i.e., “free”). The free and busy time for each attendee may be displayed as well as an aggregate of the free and busy time for the entire set of attendees. FIGS. 3a and 3b illustrate an exemplary display of an availability data set for a set of attendees on a wireless scheduling device. In FIG. 3a, a summary line 302 shows the free and busy time for all attendees in the set of attendees. In this embodiment, shaded or colored blocks represent busy time. Also displayed, as shown in both FIGS. 3a and 3b, is the availability information for each attendee 304 in the set of attendees. The application providing the display of the availability data set may be implemented on the wireless scheduling device as a PQA.

Based on the availability data received, the user may the schedule an event or appointment for the set of attendees. In one embodiment, the user may add the event to a calendar application on the wireless scheduling device. In an alternative embodiment, the user may schedule the event using the wireless scheduling device to invite the set of attendees and add the event to a calendar for the user. The set of attendees may be invited by, for example, email over the Internet. Alternatively, the user may schedule the event by directly accessing a Web site that includes a calendar application, such as a Web-based PIM. The event may then be added to the wireless scheduling device by synchronizing the Web calendar application with the wireless scheduling device using known methods of synchronization.

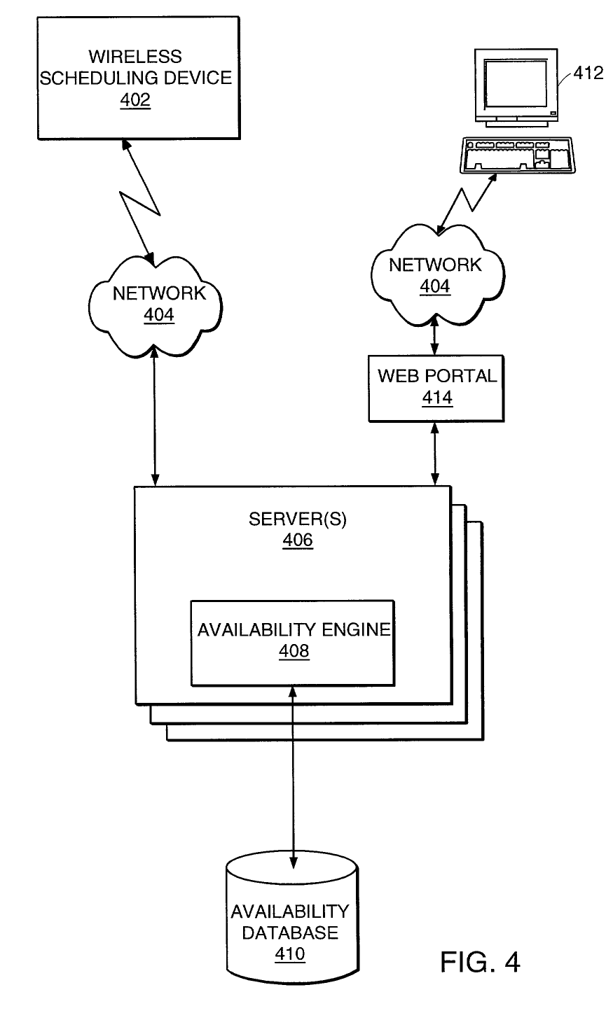

FIG. 4 shows a system for determining schedule availability for a set of attendees using a wireless scheduling device in accordance with an embodiment of the invention. A wireless scheduling device 402 may be used to access calendar data stored in an availability database 410. As discussed previously, the wireless scheduling device may be, for example, a hand held device such as a cellular telephone or Personal Digital Assistant (“PDA”). The wireless scheduling device 402 is in communication (typically via an intermediate wireless network facility) with a set of servers 406, the set having at least one member, over a network 404. The network 404 may be implemented to include the Internet.

A user creates an availability request using the wireless scheduling device 402. The availability request may include information such as an identifier for each attendee and a time period for which availability is to be determined. In one embodiment, each attendee may be identified by an email address. A user may select a time period for which to determine availability such as a particular day or period of time on a particular day. Once the user has provided the parameters of the availability request, the wireless scheduling device 402 is used to communicate the availability request to the set of servers 406.

The set of servers includes an availability engine 408. The availability engine may be a process running on at least one of the servers 406 that is in communication with the availability database 410. The availability database 410 stores calendar data for each attendee. In one embodiment, the availability database 410 is associated with a Web-based PIM. When an availability request is received, the availability engine 408 is used to retrieve availability data from the availability database 410. A search is conducted of the availability database 410 to retrieve availability data for the set of attendees specified by the user in the availability request. The search produces an availability data set that is then transmitted from the server 406 to the wireless scheduling device 402. Upon receipt of the availability data set at the wireless scheduling device 402, the availability data set may then be displayed on the wireless scheduling device 402.

As discussed above, FIGS. 3a and 3b illustrate an exemplary display of data from an availability data set on a wireless scheduling device. The availability data may be displayed as blocks representing whether an attendee is free or busy during a particular time frame. In addition, a summary 302 of the free and busy time for the entire set of attendees is displayed on the wireless scheduling device.

As discussed above with respect to FIGS. 2a and 2b, the user may access and view availability information to which they have been granted permission. In one embodiment, a user may request permission from an attendee to access their availability data via email over the Internet. Permission to access availability data may be requested using, for example, the wireless scheduling device 402. In an alternative embodiment, permission may be requested via a Web portal 414 in communication with the set of servers 406 and availability database 410 as shown in FIG. 4. A remote user 412 may access the Web portal 414 via a network 404 such as, for example, the Internet. The Web portal 414 may be, for example, a Web-based PIM, which may be used to view and maintain calendar and schedule information for a set of users.

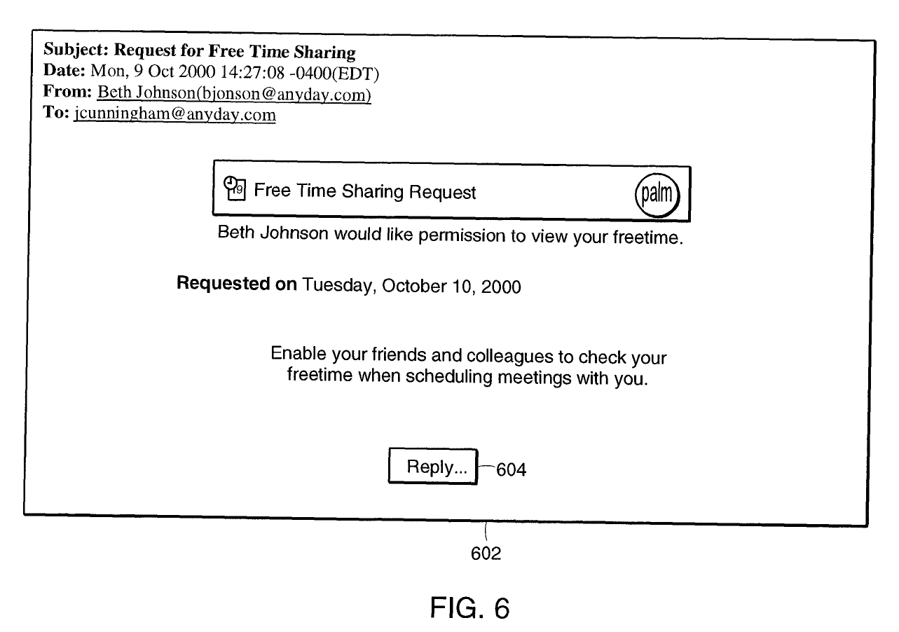

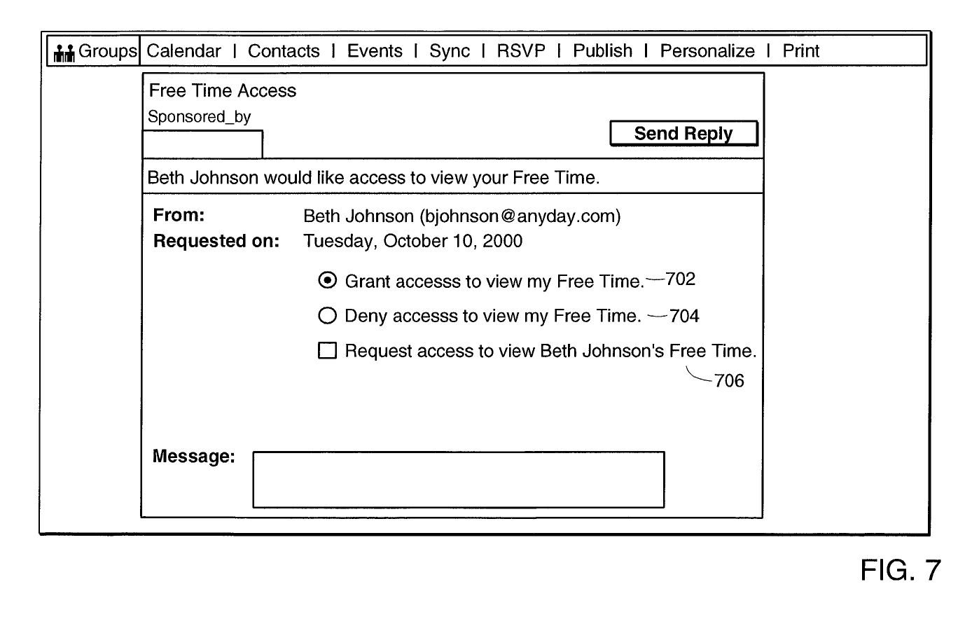

FIG. 6 shows an exemplary request for permission from an attendee to access their availability data. Preferably, the request 602 is sent via email over the Internet. The request may contain a link 604 that, when selected by the attendee, will direct the attendee to a Web page where the attendee may respond to the request. FIG. 7 shows an exemplary response regarding permission to access calendar data in accordance with an embodiment of the invention. The attendee may elect to grant access 702 to the user or deny access 704 to the user. In addition, the attendee may, in turn, request permission to access the user's availability data 706. The attendee may give a general permission to access their calendar data. Alternatively, the attendee may grant permission for a user to view calendar data for a specified date or for certain hours of a day or week. In one embodiment, the permission information is stored with each individuals calendar data in the availability database. When a user makes an availability request, only data for those attendees who have granted the user permission to access their calendar data will be provided to the user.

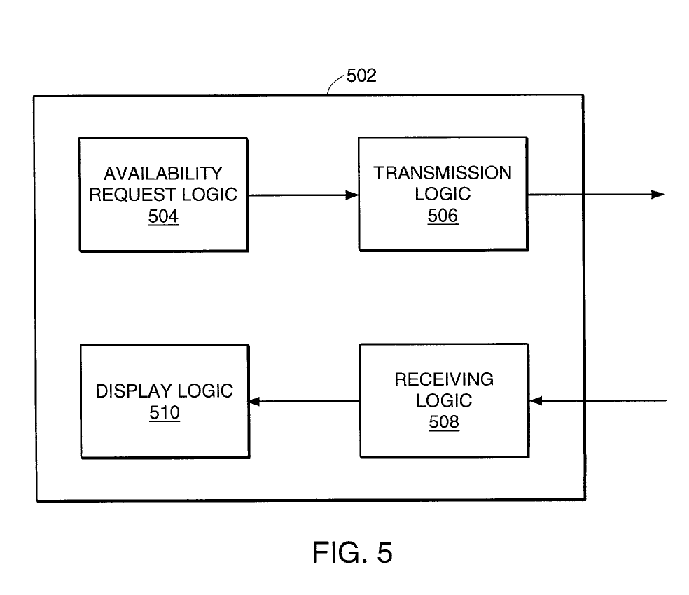

FIG. 5 is a block diagram of a wireless scheduling device used to determine schedule availability for a set of attendees in accordance with an embodiment of the invention. Wireless scheduling device 502 includes availability request logic 504 to create an availability request regarding the set of attendees. The availability request logic 504 may be an application implemented using methods known in the art such as Palm Query Applications (“PQA's). As discussed previously, the availability request may include information including an identifier for the user making the request, the starting date for which availability information is desired, the number of days of availability information desired and an identifier for each attendee for which the user wants availability information.

Transmission logic 506 is used to transmit the availability request from the wireless scheduling device 502 to a server in communication with an availability database containing calendar data for each attendee in the set of attendees. A search of the calendar data for each attendee is conducted to produce an availability data set. The server then transmits the availability data set to the wireless scheduling device 502. Receiving logic 508 receives the availability data set from the server. Display logic 510 may then be used to display data derived from the availability data set. The display logic may be an application implemented using, for example, a PQA. As discussed previously, the availability data set may be displayed as periods of time which either include an event (i.e., busy) or do not include an event (i.e., free). As shown in FIGS. 3a and 3b, the free and busy time for each attendee may be displayed as well as an aggregate of the free and busy time for the entire set of attendees.

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A method of using a wireless scheduling device to determine schedule availability for a set of attendees, the method comprising:
a. communicating an availability request to a server using the wireless scheduling device, the server having access to calendar data for each attendee in the set of attendees;
b. in response to the availability request, conducting a search of the calendar data of each attendee of the set to produce an availability data set;
c. transmitting the availability data set to the wireless scheduling device.

2. A method according to claim 1, further including:
displaying data derived from the availability data set on the wireless scheduling device.

3. A method according to claim 2, wherein the data derived from the availability data set is displayed as free time and busy time.

4. A method according to claim 1, wherein the availability request is communicated to the server via a network.

5. A method according to claim 4, wherein the network includes the Internet.

6. A method according to claim 1, wherein the availability request includes an identifier for each attendee and a time period for which availability should be determined.

7. A method according to claim 6, wherein the identifier for each attendee is an email address.

8. A method according to claim 1, wherein the calendar data for each attendee is stored in an availability database in communication with the server.

9. A method according to claim 1, further including:
scheduling an event based on the availability data set.

10. A method according to claim 9, wherein the event is scheduled using the wireless scheduling device.

11. A method according to claim 9, further including:
updating the calendar data for each attendee with the scheduled event.

12. A method according to claim 1, further including before step b:
requesting access to the calendar data for each attendee in the set of attendees.

13. A method according to claim 12, wherein access to calendar data is requested via email over the Internet.

14. A system for determining schedule availability of a set of attendees using a wireless scheduling device, the system comprising:
a first process, running on the wireless scheduling device in communication with a server, for communicating an availability request to the server, the server having access to calendar data for each attendee in the set of attendees;
a second process, running on the server, for conducting a search of the calendar data of each attendee of the set to produce an availability data set in response to the availability request; and
a third process, running on the server, for transmitting the availability data set to the wireless scheduling device.

15. A system according to claim 14, further including:
a fourth process, running on the wireless scheduling device, for displaying data derived from the availability data set on the wireless scheduling device.

16. A system according to claim 15, wherein the data derived from the availability data set is displayed as free time and busy time.

17. A system according to claim 14, wherein the availability request is communicated to the server via a network.

18. A system according to claim 17, wherein the network includes the Internet.

19. A system according to claim 14, wherein the availability request includes an identifier for each attendee and a time period for which availability should be determined.

20. A system according to claim 19, wherein the identifier for each attendee is an email address.

21. A system according to claim 14, wherein the calendar data for each attendee is stored in an availability database in communication with the server.

22. A wireless scheduling device comprising:
availability logic for creating an availability request to determine schedule availability for a set of attendees;
transmission logic for communicating the availability request to a server, the server having access to calendar data for each attendee in the set of attendees; and
receiving logic for receiving an availability data set produced at the server in response to the availability request.

23. A wireless scheduling device according to claim 22, further including:
display logic for displaying data derived form the availability data set.

24. A wireless scheduling device according to claim 23, wherein the data derived from the availability data set is displayed as free time and busy time.

25. A wireless scheduling device according to claim 22, wherein the availability request includes an identifier for each of the attendees and a time period for which availability should be determined.

26. A wireless scheduling device according to claim 25, wherein the identifier for each attendee is an email address.
